(19) United States
(12) Patent Application Publication
(10) Pub. No.: US 2005/0050790 A1
(43) Pub. Date: Mar. 10, 2005

(54) Collapsible umbrella fishing rig

(76) Inventor: Glenn Higgins, Easton, MD (US)

Correspondence Address: BANNER & WITCOFF, 1001 G STREET N W, SUITE 1100, WASHINGTON, DC, 20001, US

(21) Appl. No.: 10/306,731

(22) Filed: Nov. 29, 2002

Related U.S. Application Data
(63) Continuation-in-part of application No. 10/142,015, filed on May 10, 2002, now abandoned.

(51) Int. Cl. A01K 91/00

(52) U.S. Cl. 43/42.74

(57) ABSTRACT

An umbrella fishing rig having a housing, a teaser arm release mechanism and a plurality of collapsible teaser arms. These teaser arms are capable of moving relative to the housing from a trolling position to a collapsed position in response to the activation of the release mechanism.

This application is a continuation-in-part of U.S. patent application Ser. No. 10/142,015 filed May 10, 2002, which is hereby incorporated by reference. Benefit of the May 10, 2002 filing date is requested.

### FIELD OF THE INVENTION

This invention relates generally to fishing tackle and equipment and more specifically to an improved umbrella rig for fishing.

### BACKGROUND OF THE INVENTION

It is often necessary in bay and ocean sport fishing to use an umbrella fishing rig to help attract species of game fish. These conventional umbrella fishing rigs include a central, weighted member and a plurality of teaser arms that are rigidly secured within and extend outwardly from the weighted member. Each of these teaser arms are rigidly connected to the weighted member so that they assume a permanent, perpendicular orientation relative to the central, longitudinal axis of the weighted member and the fishing rig. Conventional umbrella fishing rigs are also used in other types of saltwater fishing and in fresh water fishing. No matter the water, the umbrella fishing rigs are sized for their intended catch.

After a fish strikes a hook associated with the umbrella fishing rig, it often becomes difficult for the fisherman to retrieve the fish due to the added resistance created by the outwardly extending teaser arms of the umbrella fishing rig. The teaser arms and any teaser elements, such as teaser lures, carried by these arms act as a significant drag force on the connection between the fishing rig and the attached fishing line, the fishing line itself and the tackle used by the fisherman. The additional drag force created by the extended teaser arms, in combination with the force applied by the fish being reeled in, can cause the fishing line and/or the fishing tackle to break prematurely and the fish to be lost.

FIG. 1 illustrates one of these conventional umbrella fishing rigs that includes a plurality of teaser arms 110 crossed at a 90-degree angle and held in place by a centrally disposed body of lead 120. A ring 105 is used to attach line from the fishing rod to the umbrella fishing rig.

As conventionally known, a lure with a hook (not shown) for catching a fish is attached to a ring 115. The teaser arms 110 shown in FIG. 1 carry a plurality of teaser lures (not shown) for attracting fish to the fishing rig. Conventional teaser lures do not include hooks as is well known in the art, but they add weight to the fishing rig. As is well known, the teaser arms of conventional umbrella fishing rigs are fixed in place and permanently secured against movement relative to the centrally disposed body 120. As a result, the teaser arms 110 cannot collapse or otherwise move along their length relative to the lead body in which they are secured.

The umbrella fishing rig is trolled behind a boat. When a fish strikes, the fisherman retrieves the rig, while fighting not only the fish but also the added drag resistance of the teaser arms. As discussed above, the force needed to fight the fish and to retrieve the fishing rig with the extended teaser arms can be greater than the tensile strength of the fishing line.

### SUMMARY OF THE INVENTION

Accordingly, it is desirable to be able to play the fish without the added resistance created by the outwardly extending teaser arms of a conventional umbrella fishing rig.

It is also an object of the present invention to provide an umbrella fishing rig that permits the teaser arms to collapse in response to a predetermined amount of force being experienced during a fish strike. This force is typically set to correspond to the amount of force generated by a fish striking a hook and the hook being set during the fish strike.

The umbrella rig of the present invention provides an improved operation/function by allowing the collapse of the teaser arms and providing a corresponding reduction in resistance through the water, thus making it easier to retrieve the fish. The collapsed umbrella fishing rig may additionally distract the fish from the fight as it collapses near or around the fish.

The present invention includes an adjustable umbrella fishing rig, which enables the collapse of its teaser arms, after a fish has been hooked. The rig can include a conical body, a plurality of teaser arms, a shaft, a washer/disc, spring and two nuts. The washer/disc can be held in place on the shaft and in turn it can hold the plurality of teaser arms in place, inside the conical housing.

In another aspect of the present invention, the collapsible umbrella fishing rig includes a housing, teaser arm release mechanism and a plurality of collapsible teaser arms that are movably secured within the housing. In one embodiment, the teaser arms can include a first end that is pivotally mounted within the housing so that they can move relative to the housing. Also, the housing can include a system that permits the rotation of these teaser arms relative to its central body/housing when a fish is hooked to the umbrella fishing rig.

It is another object of the present invention to provide a collapsible umbrella fishing rig having a plurality of teaser arms, each teaser arm having at least one teaser lure attached to each teaser arm, and further having a disc with a plurality of holes disposed in the disc, one hole of the plurality of holes being disposed in the center of the disc and having a shaft pass there through, each teaser arm passing through one of the plurality of holes and a final pair of holes for a release device, the shaft providing a means to connect the collapsible umbrella fishing rig to a fishing rod at one end and for carrying a pressure device and a retaining device for holding the pressure device on the shaft, further having a housing open on a first end and closed on a second end, wherein said shaft passes through a hole in the closed end and the disc is proximate to the open end, the pressure device is mounted on the shaft below the disc and proximate to the open end of the housing, the retaining device mounted on the shaft below the pressure device in order to retain the pressure device on the shaft and in order to provide an adjusting means for adjusting the pressure device, and further having a release device, such as a length of monofilament, attached though holes in the disc and attached to a lure with a hook by means of a swivel or other suitable means.

### BRIEF DESCRIPTION OF THE DRAWINGS

The invention can best be described with reference to the detailed description and the following figures where:

FIG. 1 is a conventional umbrella fishing rig.

FIG. 2 shows a side elevation of a collapsible umbrella fishing rig according to the present invention in a trolling position; FIG. 2A is an isolated top plan view of the disc illustrated in FIG. 2.

FIG. 3 shows an alternative embodiment of the housing according to the present invention.

FIG. 4 is a top elevation view of the collapsible umbrella fishing rig of FIG. 2.

FIG. 5 illustrates the umbrella fishing rig according to the present invention in a collapsed position.

FIGS. 6-8 are schematic cross sectional views of the housing according to the present invention with alternative embodiments for maintaining the teaser arms in a trolling position, a centrally located shaft within the housing is not illustrated in these figures.

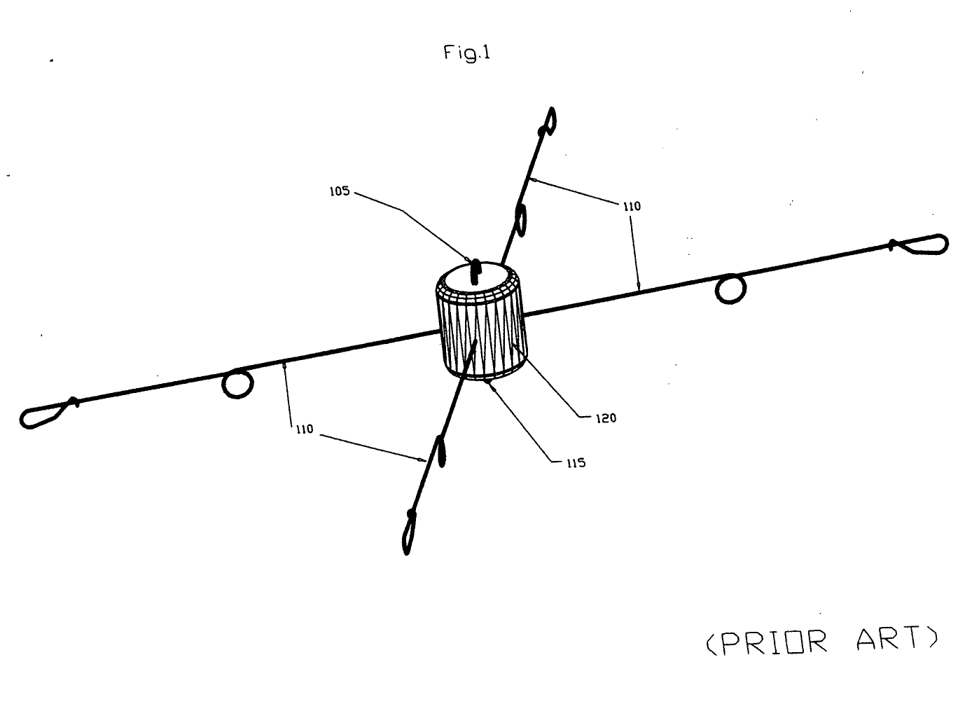

### DETAILED DESCRIPTION OF THE PREFERRED EMBODIMENTS

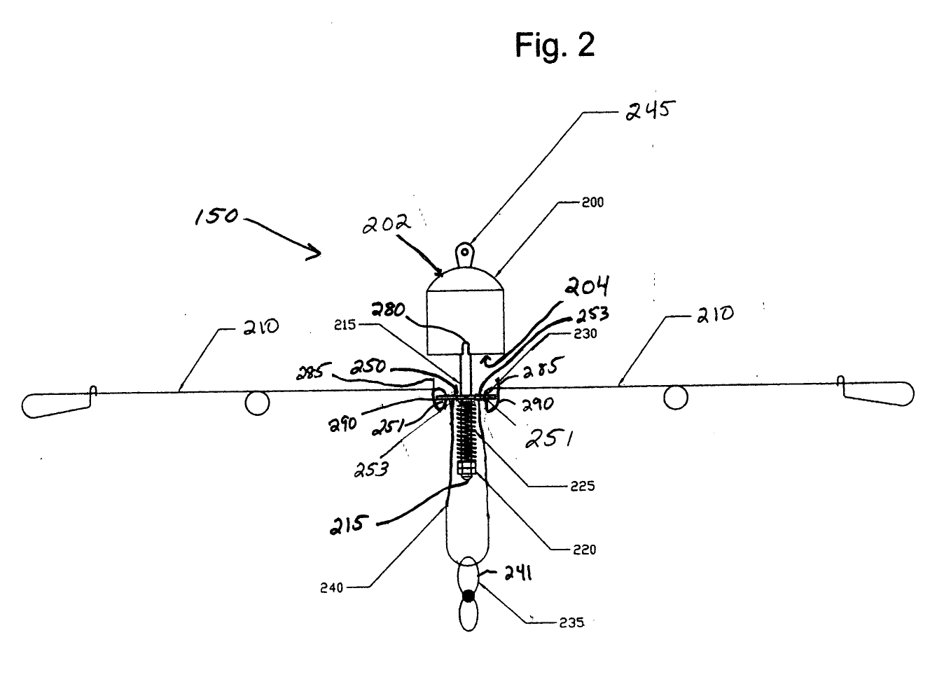

Referring now to FIG. 2, the collapsible umbrella fishing rig includes a housing 200, which has a hollow or partially hollow body that is open on one end 204 and closed on the other end 202. In another embodiment, the closed end 202 could include flow openings that permit water to flow through the housing 200 in order to reduce drag on the fishing rig 150 as the rig is being reeled in by the fisherman. The housing 200 could be made of plastic, metal, wood or other suitable materials that can be used in saltwater or fresh water. At least one portion of the housing 200 can be formed of a densely weighted material such as lead or include weight(s) to aid in its ability to sink to a desired depth. The housing 200 is of any shape that would reduce resistance, such as conical or, as depicted in FIG. 2, cylindrical with a hemispheric top portion.

A shaft 215 passes through the center of the closed end 202 of the housing 200 and out through the open end 204 of the housing 200. The end 245 of the shaft 215 that protrudes through the top of the closed end 202 of the housing 200 can be attached to a fishing line extending from a fishing rod or the like (not shown) by extending the fishing line through an opening formed in the shaft 215 by conventional techniques, such as drilling, or by attaching the fishing line to a swivel or other similar device. Other known ways of attaching a fishing line to a housing can also be used.

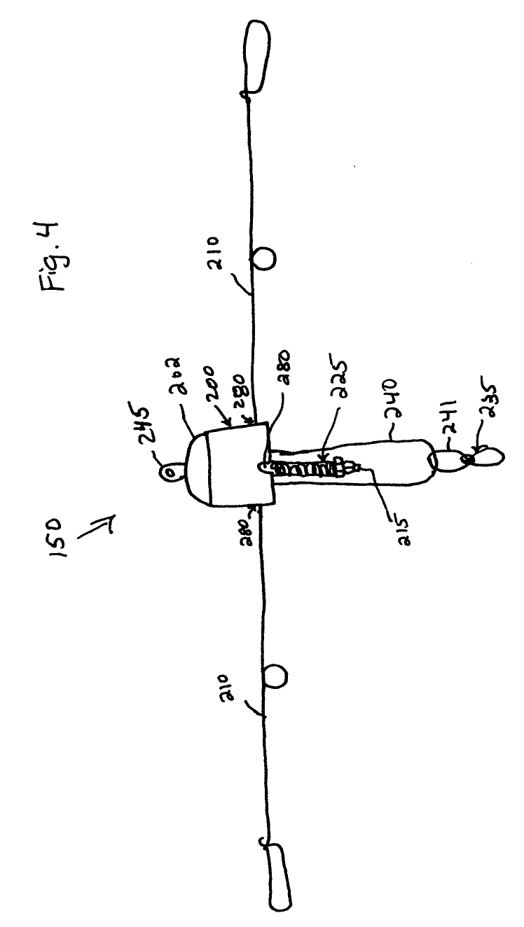

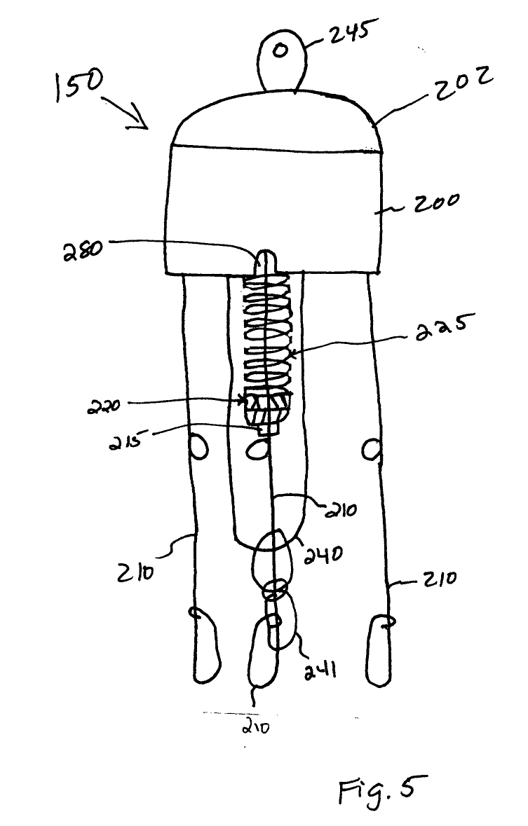

The shaft 215 protrudes through a disc 230 as illustrated. The disc 230 includes a plurality of holes 250 and 251. One of these holes is a centrally positioned hole 250 through which the shaft 215 passes. The other holes 251 are positioned about the center hole 250 and each receive a respective one of the collapsible teaser arms 210. In one embodiment, a portion of the collapsible teaser arms 210, such as a loop, extends through a respective one of the holes 251 to pivotally secure the ends of the teaser arms 210 relative to the housing 200 and to permit the teaser arms 210 to move from a trolling position (FIG. 4) to a collapsed position (FIG. 5) when a release device 235 operates. In the embodiment illustrated in FIG. 2, additional holes 253 in disc 230 connect a release device 235 (discussed below) to the disc 230. The holes 253 can be located between the center hole 250 and the peripherally arranged holes 251 about the disc 230. These holes 253 can be arranged between approximately about 90° and 180° apart from each other. As a result, the disc 230 can include two, three or four holes 253. More than four holes 253 could also be employed to secure the release device 235 to the disc 230.

In the illustrated embodiment, the release device 235 is connected to the disc 230 so that the disc 230 will shift within the housing 200 and permit the teaser arms 210 to move from their trolling position (FIG. 4) to their collapsed position (FIG. 5) in response to a predetermined amount of force being applied to the fish hook. The release device 235 extends in line with, and between, the disc 230 and the fish hook on which the fish will be caught. In one embodiment, the release device 235 includes a plurality of elongated members that can be connected to both the disc 230 and the fish hook. For example, the release device 235 can include elongated pieces of material 240 such as flexible metal wire, a rigid metal rod, a braided fabric or monofilament connected to the disc 230. The release device 235 can also include at least one swivel 241 or other known connector attached to the length of monofilament 240 or one of the other mentioned suitable materials such as metal wire that is commonly used to catch fish that require steel wire leaders.

As shown in FIG. 2, a pressure device 225 such as a spring or coil of wire or some other suitable material passes over the shaft 215 in a position adjacent to disc 230. The pressure device 225 can extend outward of the housing 200 and proximate the open end 204 of the housing 200. The pressure device 225 can extend any distance into the housing 200 that permits it to make contact with disc 230 and bias the disc 230 into the housing 200. The pressure device 225 can be replaced by another pressure device 225 having a different strength in order to adjust the pressure applied to the disc 230.

A retaining device 220, can include a plurality of threaded nuts as shown in FIG. 2. The threaded nuts are used to retain the pressure device 225 on the threaded shaft as well as to adjust the pressure required to collapse the umbrella fishing rig by the intended catch. Alternatively, the retaining device 220 could include a pin that extends through one of a plurality of spaced passages that extend through shaft 215 or some other known retaining member(s). The retaining device 220 may be made of metal or plastic or some other suitable material that can resist the forces, such as compression, applied by the pressure device 225.

In any of the below-discussed embodiments, the housing 200 has a plurality of small openings, preferably inverted U-shaped openings 280, spaced peripherally around the open end 204 of housing 200. These openings 280 are aligned with the peripherally arranged holes 251 of disc 230 and permit the teaser arms 210 to move relative to the housing 200 and assume their collapsed position (FIG. 5) relative to the housing 200. In one preferred embodiment, a terminal end of the teaser arms 210 each have a loop 290 that passes through peripheral holes 251. Each loop 290 has a raw end 285 that extends a short length above the teaser arm 210. This short length is greater than the height of the small openings 280 in housing 200 and sized so that it can contact the inner wall of housing 200 when the umbrella fishing rig is at rest or is being fished prior to a fish strike. The small openings 280 in housing 200, the disc 230 having peripherally arranged holes 270 aligned with openings 280 of housing 200 and loops 290 of teaser arms 210 cooperate with at least each other to cause the raw ends of the teaser arms 210 to engage the inner wall of the housing 200 and thereby maintain the teaser arms 210 in their substantially perpendicular orientation relative to the housing 200—their trolling position. In the embodiment shown in FIG. 2, the pressure device 225 cooperates with the retaining device 220 to causes the disc 230 to hold the raw ends 285 of the teaser arms 210 in contact with the inner wall of the housing 200 and prevent premature collapse of the teaser arms 210 prior to a fish strike.

In preparation for use, a fishing line is attached to the shaft 215. Also, teaser lures—lures without hooks (not shown)—are attached to teaser arms 210 and a lure with a hook (not shown) is attached to release device 235. In use, the teaser arms 210 of the umbrella fishing rig assume their trolling positions and the umbrella fishing rig is trolled behind a boat. When a fish strikes the lure (not shown) attached to release device 235, the resultant tension forces and related actions cause the disc 230 to move rearward—toward the lure and the fish. In the embodiment shown in FIG. 2, the disc 230 moves toward retaining device 220 and separates the teaser arms 210 from the portion of the housing 200 that holds the arms 210 in their trolling position. The teaser arms 210 then pivot relative to the housing 200 and disc 230 in response to their movement within the water and assume their collapsed position (FIG. 5). In the collapsed position, the teaser arms 210 extend in a direction away from the housing 200 that is at an angle to the trolling position that the teaser arms 210 occupy before the fish strike (FIG. 4). In one embodiment, the teaser arms 210 extend in their collapsed state in a direction that is substantially parallel to a longitudinal axis of the housing 200 and substantially perpendicular to their trolling position, as shown in FIG. 4. The collapsed position allows the teaser arms 210 to move away from the sides of the housing 200 and, instead, assume a position behind the housing 200 so that a fisherman can retrieve the fish using less resistance than required when fishing with a conventional umbrella fishing rig. In at least one embodiment, the housing 200 is sized and shaped so that the aerodynamics of the housing 200 create a flange and divert water around and away from the teaser arms 210 as the fish is being played and reeled in by the fisherman.

In the collapsible umbrella fishing rig according to the present invention, the housing 200, shaft 215, pressure device 225, retaining device 220 and the teaser arms 210 can be made of any material able to withstand a water environment including the saltwater environments encountered during bay and ocean sport fishing. The materials can include stainless steel, aluminum, bronze, plastic or rubber.

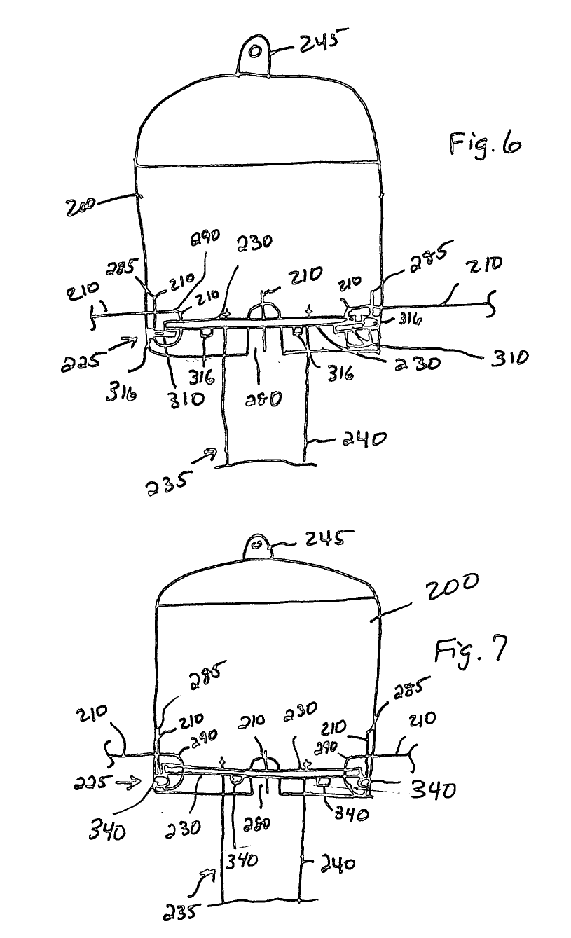

In an alternative embodiment, illustrated in FIG. 6, the pressure device 225 and the retaining device 220 can include a plurality of members 310, including springs or elastic members, that each extend inwardly from an interior wall of the housing 200 and are biased against the disc 230. In this embodiment, the pressure device 225 includes resilient metal or synthetic members 310 that contact a lower surface of the disc 230 and retain the position of the disc 230 within the housing 200 until a predetermined force is applied to the disc 230 by the release device 235 in response to a fish being hooked. When the force created by hooking the fish is greater than the spring constant of the resilient material of the each member 310, each member 310 deflects under the force created by the hooked fish. The retaining device 220 includes a connection 316 between the pressure member 310 and the housing 200 such as a weld, a pin or a threaded member having a cooperating nut that is positioned on the external surface of the housing.

In another alternative embodiment, the disc 230 can be retained within the housing 200 and the teaser arms 210 in their trolling position by a pressure device 225 including a plurality of inwardly extending protrusions 340 on the interior surface of housing 200 as shown in FIG. 7. These protrusions 340 contact the disc 230 within the housing 200 and prevent the disc 230 from moving prior to a fish strike. During the fish strike, as the hook is set and the fish begins to fight, the disc 230 is capable of overcoming the support of the protrusions by either deflecting the sidewall of the housing 200 or itself. When this occurs, the teaser arms 210 will be free to move from their trolling position to their collapsed position. As with all of the embodiments discussed herein, the amount of pressure needed to cause the disc 230 to move relative to the housing 200 will vary depending on the size of the umbrella fishing rig and the intended size of the catch.

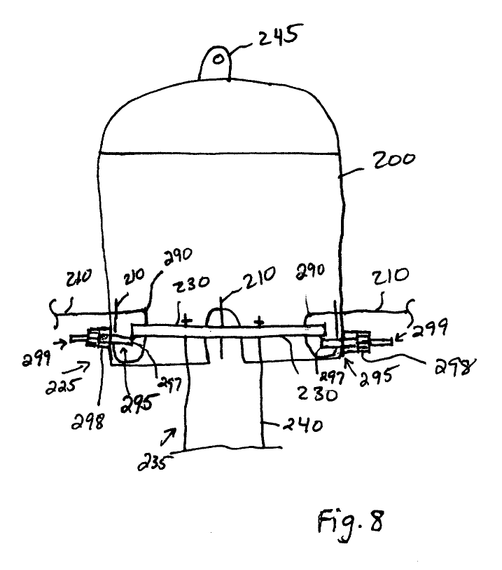

FIG. 8 shows yet another alternative embodiment, instead of a single pressure device 225 deployed on shaft 215, a plurality of adjustable pressure devices 295, having a predetermined rigidity for the intended catch, are deployed inside of housing 200 such that when a fish strikes and disc 230 is pulled along the length of the housing and through the open end of housing 200, teaser arms 210 are disengaged and collapse toward the fish. For example, the plurality of pressure devices 295 are deployed inside housing 200 and include small rods 296 that go through the side walls of housing 200 at points not interfering with the peripherally arranged holes in disc 230 because this would interfere with teaser arm engagement and release/collapse. Preferably, the end 297 of rod 296 that meets the disc 230 has a small flat end piece of any shape affixed thereto to put even pressure against disc 230. The end 299 of the rod 296 that extends through the side wall of the housing 200 can be fitted with adjusting means, for example threaded nuts 298 for threading onto the end 299 of the rod 296 that extends through housing 200, to make small adjustments in the distances that the rods 296 extend into the housing 200 and thus, the pressure required to cause the disc 230 to move toward the fish and properly operate the collapsible umbrella fishing rig 150. Equivalently, the disc 230 may have enlarged and flattened edges at places designed to meet the rods 296 as shown in FIG. 8. Any adjusting device 298 for adjusting the amount of pressure required to permit teaser arms 210 to disengage and collapse for this embodiment needs to be adjusted such that all pressure devices are adjusted evenly or teaser arms 210 will not release properly.

In operation, once a fish strikes a fishing lure with a hook connected to any of the above-discussed release devices 235, the striking fish pulls the lure, which overcomes the pressure device 225 and draws disc 230 toward the fish through the open end of housing 200. As disc 230 is drawn through the open end 202 of housing 200, the raw ends 285 of loops 290 of teaser arms 210 drop below the top end of openings 280 of housing 200, thereby effecting the release of teaser arms 210 from their trolling positions and allowing the teaser arms 210 to rotate or otherwise collapse toward the fish into their collapsed positions. The force required to overcome the pressure device 225 can be easily adjusted in the field to fit the intended catch.

Depending upon the environment in which the collapsible umbrella fishing rig described herein is used and the intended catch, the size of the spring or coil and, therefore, the spring constant is adjustable. That is, while some adjustment is made to the force required to compress the spring to fit the intended catch by adjusting (tightening or loosening) the retaining device, in the alternative the spring or coil itself is easily replaced with a spring having a different (greater or lesser) spring constant or compression ratio based on the intended catch.

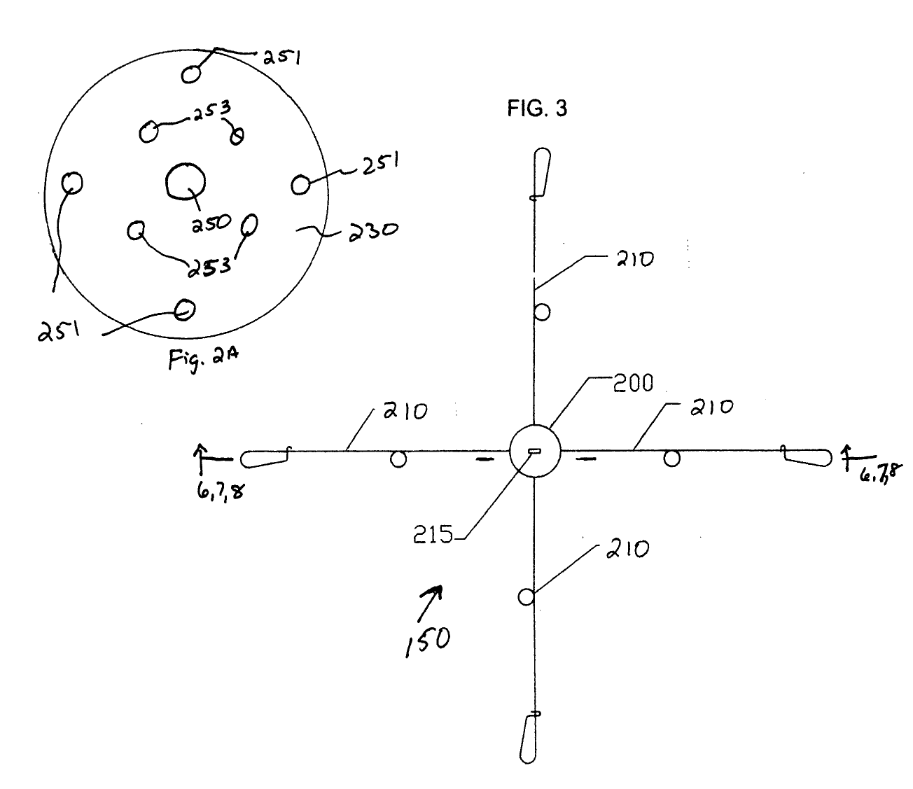

FIG. 3 shows an alternative embodiment of housing 200 of the collapsible umbrellas fishing rig that is similar to the housing 200 depicted in FIG. 2 except that shaft 215 does not protrude through the closed end of housing 200 but rather is attached centrally to the interior of the closed end of housing 200. In this embodiment housing 200 has an integral portion on the exterior of the closed end of housing 200 forming a loop 260 or similar arrangement through which a fishing line (e.g., monofilament) could be threaded for attachment of the collapsible umbrella fishing rig to a fishing rod.

It should be clear from the foregoing that the objectives of the invention have been met. While particular embodiments of the present invention have been described and illustrated, it should be noted that the inventions is not limited thereto since modifications may be made by persons skilled in the art. The present application contemplates any and all modifications within the spirit and scope of the underlying invention disclosed and claimed herein.

1. A collapsible umbrella fishing rig comprising:
a plurality of teaser arms, each teaser arm having at least one teaser lure attached to each said teaser arm;
a disc having a plurality of holes, a subset of said holes arranged peripherally in said disc, a center hole and at least one pair of holes approximately 180° apart from each other and between said peripherally arranged holes and said center hole, said plurality of teaser arms attached to said collapsible umbrella fishing rig through said peripherally arranged holes in said disc;
a housing having a top and a bottom, said bottom being open, said disc disposed within said housing proximate to said open end, said housing further having a hole in said top;
a shaft disposed in said housing through said opening in said top of said housing and passing through said center hole of said disc and extending for a length beyond said housing, said shaft passing through said top of said housing and further having a hole therein, said hole disposed to receive a first length of fishing line connected to a fishing rod;
a release device formed by a second length of fishing line forming a loop attached to and through said pair of holes in said disc, said loop attached to a length of fishing line on which is disposed a fishing lure having a hook;
a pressure device disposed on said shaft below said disc; and
a retaining and adjusting device disposed on said shaft below said pressure device, said retaining and adjusting device being used to retain said pressure device on said shaft and to adjust a pressure at which said teaser arms of said collapsible umbrella fishing rig will collapse toward a fish when said fish strikes said fishing lure.

2. The collapsible umbrella fishing rig according to claim 1, wherein said pressure device is replaceable by a second pressure device of a different size and compression ratio based on an intended catch.

3. The collapsible umbrella fishing rig according to claim 1, wherein said housing is conical.

4. The collapsible umbrella fishing rig according to claim 1, wherein said housing is hemispheric with cylindrical sides.

5. The collapsible umbrella fishing rig according to claim 1, wherein a portion of said shaft that extends below said disc is threaded to engage said retaining and adjusting device.

6. The collapsible umbrella fishing rig according to claim 1, wherein said housing further has small openings and said teaser arms have a loop with a raw end, said loop having been formed by inserting said raw end through said peripherally disposed holes of said disc and folding said raw end over a peripheral edge of said disc thus forming said loop, said raw end having a height greater than said small openings, said raw end engaging said housing on an inside wall and holding said teaser arms in an engaged position while trolling, once a fish strikes a fishing lure with a hook deployed on said release device, the striking fish pulls the lure, which draws disc toward the fish through the open end of housing, as disc is drawn through the open end of housing, the raw ends of said loops of said teaser arms drop below the top end of said small openings of said housing, thereby effecting the release of teaser arms from their engaged positions and allowing teaser arms to collapse toward the fish.

7. A collapsible umbrella fishing rig comprising:
a plurality of teaser arms each carrying at least one teaser lure;
a disc having a plurality of holes, a subset of said holes arranged peripherally in said disc, a center hole and at least one pair of holes approximately 180° apart from each other and between said peripherally arranged holes and said center hole, said plurality of teaser arms attached to said collapsible umbrella fishing rig through said peripherally arranged holes in said disc;
a housing having a top and a bottom, said bottom being open, said disc disposed within said housing proximate to said open end, said top end of said housing have integral thereto an extension for receiving a first length of fishing line connected to a fishing rod;
a shaft disposed in said housing and passing through said center hole of said disc and extending for a length beyond said housing,
a release device formed by a second length of fishing line forming a loop attached to and through said pair of holes in said disc, said loop attached to a length of fishing line on which is disposed a fishing lure having a hook;
a pressure device disposed on said shaft below said disc; and
a retaining and adjusting device disposed on said shaft below said pressure device, said retaining and adjusting device being used to retain said pressure device on said shaft and to adjust a pressure at which said teaser arms of said collapsible umbrella fishing rig will collapse toward a fish when said fish strikes said fishing lure.

8. The collapsible umbrella fishing rig according to claim 7, wherein said pressure device is replaceable by a second pressure device of a different size and compression ratio based on an intended catch.

9. The collapsible umbrella fishing rig according to claim 7, wherein said housing is conical.

10. The collapsible umbrella fishing rig according to claim 7, wherein said housing is hemispheric with cylindrical sides.

11. The collapsible umbrella fishing rig according to claim 7, wherein a portion of said shaft that extends below said disc is threaded to engage said retaining and adjusting device.

12. The collapsible umbrella fishing rig according to claim 7, wherein said housing is formed of plastic.

13. The collapsible umbrella fishing rig according to claim 7, wherein said housing is formed of rubber.

14. The collapsible umbrella fishing rig according to claim 7, wherein said housing further has small openings and said teaser arms have a loop with a raw end, said loop having been formed by inserting said raw end through said peripherally disposed holes of said disc and folding said raw end over a peripheral edge of said disc thus forming said loop, said raw end having a height greater than said small openings, said raw end engaging said housing on an inside wall and holding said teaser arms in an engaged position while trolling, once a fish strikes a fishing lure with a hook deployed on said release device, the striking fish pulls the lure, which draws disc toward the fish through the open end of housing, as disc is drawn through the open end of housing, the raw ends of said loops of said teaser arms drop below the top end of said small openings of said housing, thereby effecting the release of teaser arms from their engaged positions and allowing teaser arms to collapse toward the fish.

15. A collapsible teaser arm umbrella fishing rig comprising:
a housing;
a teaser arm release mechanism, wherein said teaser arm release mechanism is activated by a fish strike; and
a plurality of teaser arms capable of moving relative to said housing from a trolling position to a collapsed position in response to activation of said release mechanism by a fish strike, said teaser arms each carrying at least one teaser lure.

16. The collapsible umbrella fishing rig of claim 15 wherein said teaser arm release mechanism comprises a moveable member positioned within said housing and a release device connected to said moveable member, said moveable member engaging a portion of said teaser arms when said teaser arms are in the trolling position; and wherein said fishing rig further comprises a pressure device in contact with said moveable member positioned within said housing and a retaining device for maintaining said pressure device in contact with said moveable member for holding said teaser arms in said trolling position.

17. The collapsible umbrella fishing rig of claim 16 wherein said pressure device includes a spring.

18. The collapsible umbrella fishing rig of claim 15 wherein said housing includes a plurality of openings for receiving said teaser arms, said openings being sized such that a portion of each said teaser arm positioned within said housing is capable of rotating relative to said housing as said teaser arms move from their trolling position to their collapsed position.
